(19) United States
(12) Patent Application Publication
(10) Pub. No.: US 2014/0180803 A1
(43) Pub. Date: Jun. 26, 2014

(54) SYSTEM AND METHOD FOR ONLINE GROUP BUYING

(71) Applicant: Ali Sedighian, Toronto (CA)

(72) Inventor: Ali Sedighian, Toronto (CA)

(21) Appl. No.: 14/141,245

(22) Filed: Dec. 26, 2013

Related U.S. Application Data
(60) Provisional application No. 61/745,845, filed on Dec. 26, 2012.

(51) Int. Cl. G06Q 30/02

(52) U.S. Cl. CPC G06Q 30/0253
USPC 705/14.51

(57) ABSTRACT

A business process model for online group buying offers discount based on time of visit. It enables businesses to conduct some customers to visit the store in off-peak hours. If patrons visit business during off-peak hours they receive maximum amount of discount, while visiting during rush hours carries minimum amount of discount for customers. Hour's status (peak or off-peak), discount values and minimum of coupons to activate deals are defined by business. The deals are initiated by users and approved by business.

This application claims priority under 35 U.S.C. §119 from U.S. Provisional Patent Application 61/745,845 for a “SYSTEM AND METHOD FOR ONLINE GROUP BUYING,” filed Dec. 26, 2012, by A. Sedighian, which is hereby incorporated by reference in its entirety.

The disclosed system and methods are directed to group buying purchases, where merchants give a discount to a group buyer in order to promote the businesses.

### BACKGROUND AND SUMMARY

The following disclosure characterizes a system and method for facilitating online purchasing or buying activities by one or more members of a group or collective. In various merchandizing systems, there are often high charges that significantly reduce the revenue that may be obtained by the merchant. For example, coupon-driven systems such as Groupon can reduce a merchant's revenue by fifty percent. Moreover, in such systems it is often the case that there is a delay in remitting the revenue to the merchants.

From a consumer or purchaser's perspective, such systems also have negative characteristics, including a limit or lack of choices of the goods/services that may be purchased. The consumers also lack any “power” in determining the products or services offered or the discount rate. And, aside from separate networks, there are no social interaction platforms that allow consumers to discuss and make a purchase decision.

The disclosed system and method, which may be referred to as PlayDeal™, provides a platform for users to design and send deal request to merchants, where the deal requests are for a specific purchase, including time and date. Such deals are initiated in real time and provide opportunities for consumers to obtain goods and services (i.e., offerings) at a discount if they are willing to agree to a particular time to visit the merchant. The discount obtained by the consumer is a function of the time of the transaction; where the consumer maximizes discount during off-peak hours, days, etc. For the merchant, the benefits include higher margins on sales, efficient capacity utilization, and the ability to provide time-sensitive offerings to consumers.

One aspect of the disclosed embodiments includes a reverse deal (U-Deal) and discount based on time of redemption. The innovation of reverse deal offers deals based on time of redemption where users design and send their requests for a deal to merchants, unlike conventional online sales models where merchants post their offers. Afterwards, user and merchant have a chance to negotiate on discount and time of visit. If a user redeems the deal “coupon” in rush hour, the user receives a minimum amount of discount whereas if redemption occurs during off-peak times the user receives maximum value (discount) on the transaction.

Disclosed in embodiments herein is a system for sourcing a featured item for online aggregate purchase by customer that have proposed the terms of the transaction, where the merchant can increase transactions during idle or slow times. More specifically, one aspect of the system is that it is designed to distribute customers over working hours in the sense that users who visit the business in the course of off-peak working hours receive the maximum amount of discount while users can redeem with minimum amount of discount during rush hours. The system uses discount to encourage the customers to make their purchase in idle times so that business covers its expenses. The system includes a repository configured to store the list of businesses and their products specifications. Users can design their requests regarding product parameters. This request goes through a ranking system which assigns a number value to the deal request representing the likelihood of approval; thereby a user can adjust the request to elevate this value. In case of high rank, requests are put into action; otherwise, the user can adjust the request or simply drop it. Businesses can tune the recommender system by entering their information. Some requests are directly sent to businesses, which in turn, businesses approve or deny the request.

### BRIEF DESCRIPTION OF THE DRAWINGS

FIG. 1 illustrates an exemplary workflow for the disclosed system;

FIG. 2 depicts an exemplary structure for the Deal Ranker functionality as disclosed herein;

FIG. 3 illustrates internal structure for the recommender system;

FIG. 4 provides an illustrative example of a confidence zone as disclosed herein;

FIGS. 5 and 6 are illustrations of exemplary transaction workflows in accordance with embodiments of the disclosed system and method;

FIGS. 7 and 8 are graphical representations of the variable relating to the number of customers and discount level, respectively;

FIGS. 9 and 10 are representations the the power determined by the DealRanker functionality as further described relative to an example; and

FIG. 11 is an exemplary characterization illustrating the relationships of the various users.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

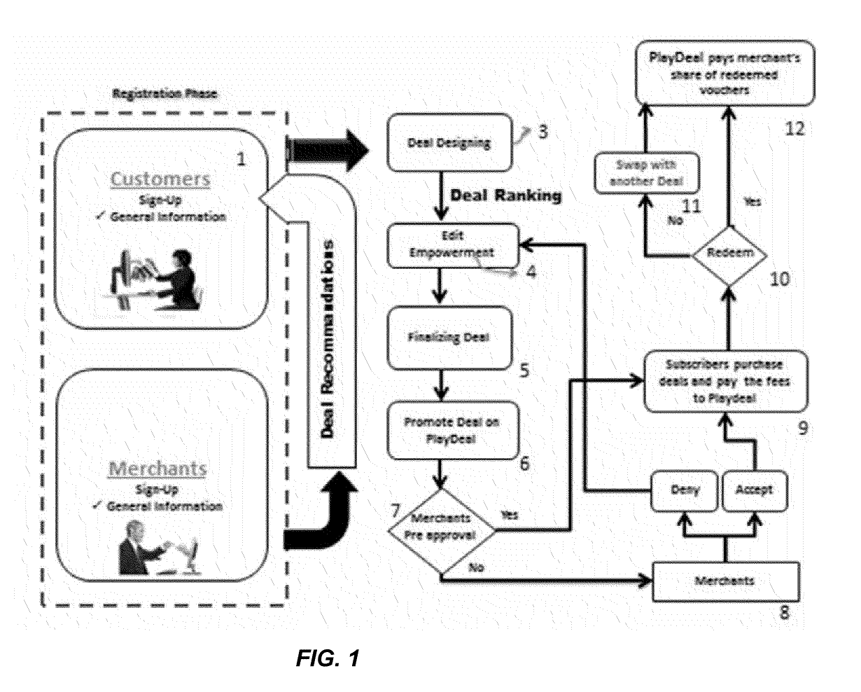

Referring to FIG. 1, disclosed therein is an exemplary workflow for the online group buying system. Although there are various technologies (web service, mobile application(s), cloud storage, user modeling, recommender system) that may be employed to operate the disclosed system and carry out the process steps described below, one embodiment contemplates the use of a database for Business and User Profiles as well as transactions. Such a database may be implemented using one or more database software technologies, for example, PostGre, MySQL, or Oracle. A RESTful web service employing interpreted scripting languages such as Python/PHP, may be used to connect to Social networks, Search engines, deal providers, and business listing websites. The system may further send push notifications. The Deal Ranker (Haskell), ranks merchants behaviour with the help of approval history and input parameters (Deal zone) and lets the user know about the likelihood of approval by measuring the “distance” of a user's request from a model for the merchant. Deal Ranker is used to determine the likelihood that a proposed deal from a customer would be accepted by a merchant based on the merchant Deal Zones.

In one embodiment, the website/server is a PHP Server that is double-faced (merchants and end users), and in a suitable code (e.g., HTML5/CSS3 (Javascript), provides a user interface in the form of a business administration panel, a user panel and SEO panel. It is also contemplated that the user-interfaces may be suitable with smartphone based applications. Also contemplated is a location-based service that incorporates location in association with preferences, deals, etc. As noted, in a system implementing the online group buying described herein there would be database memory and similar storage technologies employed to track the customers, merchants, pending and accepted deals, etc.

As illustrated, the flow of actions is initiated with a customer 1 and is completed by paying merchants 12. After a customer is signed up, a deal is designed 3 and it is then ranked. At point 4 the deal may be edited based upon ranking and/or whether it is accepted by a merchant. Next, the deal is finalized at 5, and may then be promoted on the PlayDeal website, smartphone applications, etc. in order to generate interest of other customers for the same or similar deals. As indicated at 7, the deal may have been pre-approved by the merchant, and of so, the process continues at 9. Otherwise, the deal is presented to the merchant at 8 and the merchant can accept or deny the deal. In the event of denial, as alluded to earlier, the deal may be edited by the customer at 4 in order to make it acceptable to the merchant.

Once a deal has been approved, or in the case or a preapproved deal, the users are able to subscribe to the deal and to arrange payment for the deal at 9. The deal is recorded for each user in a database and the deal is then entered for redemption by the purchasing customer(s). As reflected at 11, the customers have the option of swapping the deal(s) purchased with other customers's deals. Finally, PlayDeal pays the merchant for the merchant's share of the redeemed vouchers.

In one embodiment the system and method provide a customer-merchant processing system for sourcing a featured item for online aggregate purchases. The system is designed to distribute customers over operating hours/days in the sense that users who visit the business in the course of off-peak times receive a maximum discount while users can still redeem a deal during rush times but receive only a minimum discount. The system uses discount to encourage customers to make their purchase in idle times, so that merchants more efficiently cover expenses. In one embodiment of the system, a repository is configured to store the list of businesses and their product specifications. Users can design their requests regarding product parameters. This request goes through a ranking system (deal ranking), which assigns a number value to the deal request representing the likelihood of approval. Thus, a user can adjust the request to increase this value and the likelihood of acceptance by the merchant. In case of a high rank, requests may be pre-approved and put into action; otherwise, the user can adjust the request or simply drop it. Businesses can tune the recommender system by entering their information. Some requests are also directly sent to businesses, which in turn, businesses approve or deny the request.

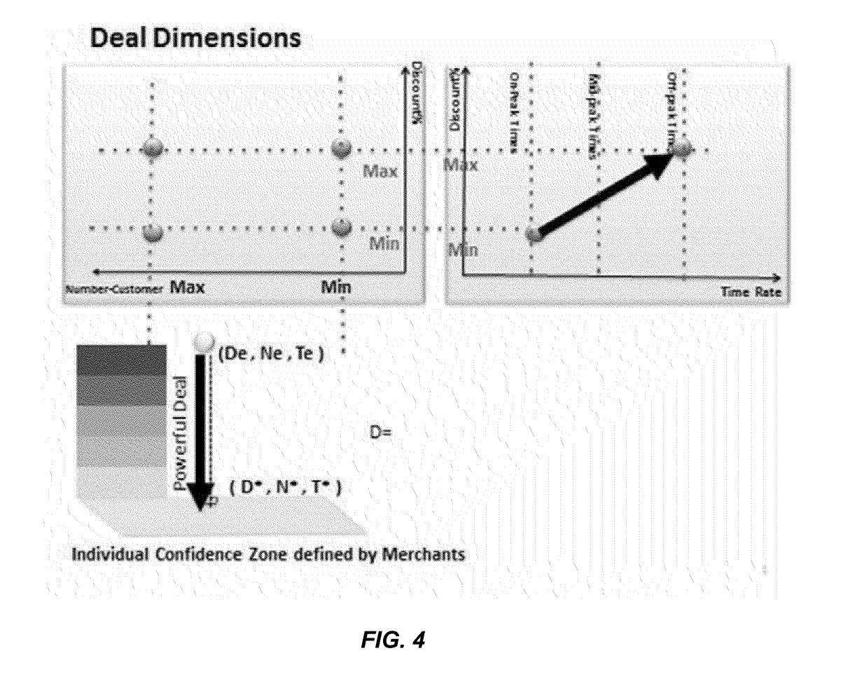

In order to construct any deal, the system employs a customer interface to take at least three main inputs from a user (customer): time of redemption, number of coupons, and discount. Similarly, the deal ranker takes inputs from merchants to establish a confidence zone as further characterized relative to FIG. 4. In essence, the confidence zone is a “boundary” where deals are accepted or more likely to be approved by merchants. The confidence zone can define status of hours e.g., peak or off-peak, as well as an amount of discount for various hours. For example business can define maximum discount for off-peak hours of say 1:30-3 pm on Wednesday and Thursdays. It is also contemplated that the merchant may define minimum numbers of deal coupons that must or should be purchased in order to activate a deal.

As illustrated with respect to step 7 in FIG. 1, requests may be accepted without merchant direct approval based upon them appearing in a confidence zone determined by the merchant. Otherwise requests out of this zone are directed to the merchant for approval.

It is further contemplated that this disclosed system and methods operate in real time and that the system receives requests in real-time, redirects the request immediately to businesses, and subsequently, the decision will be send back to users. Moreover, using the disclosed system, users/customers can send their requests via a web page viewed in a browser or mobile application (“app”) on a smartphone, and the merchants receive the proposed deals on the mobile or website platform.

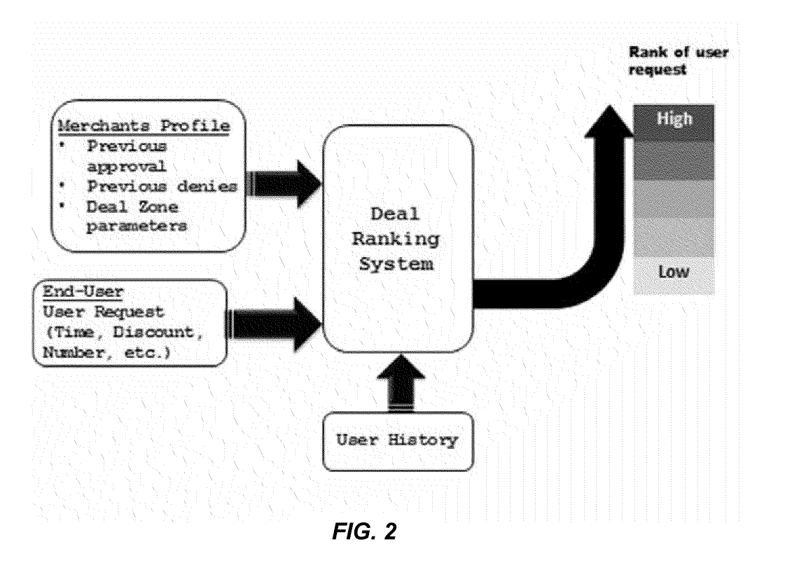

This process may also utilize or leverage two other components to create a better user experience: Deal Ranker and Deal Recommender which are further described below. Referring also to FIG. 2, depicted therein is the structure of Deal Ranker. The Deal Ranker component takes input from a Merchant's Profile and User history, and using such information maps out a user request to a point in the ranking spectrum. In other words, the proposed deal is ranked to characterize, preferably in near real-time, the likelihood that the deal will be accepted based upon merchant information and past deal acceptance. As will be appreciate, the characteristics of the proposed deal from the end user (customer) are compared against information stored in association with the merchant's profile, along with the user history, to create a ranking for the deal. As illustrated the scaled may be over a range of low to high for likelihood of acceptance by the merchant.

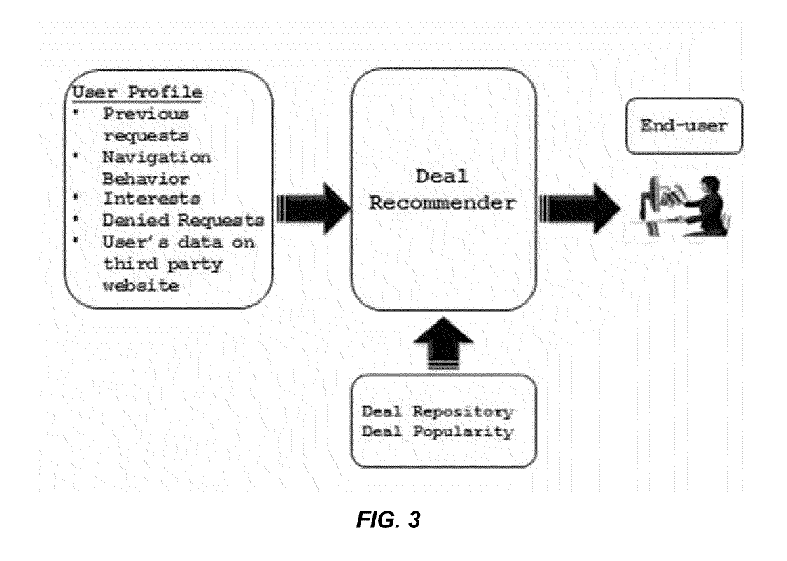

Referring to FIG. 3, depicted therein is an exemplary internal structure of the deal recommender system. This system receives user's information from a database of user profiles, or other third-party data (e.g., Facebook). For example, a user can install a PlayDeal application on a social network in order to share their experience or share its profile for better recommendations. This system is used to make personalized offering or corresponding denied requests to new business. In one embodiment, the recommender system uses decision-making algorithms (e.g., Decision Tree, SVM) to map out deals to users and failed requests to new businesses based on their interest. Also input is information on other deals from a deal repository, (e.g., deal popularity), and the end user is provided with a recommendation as to exemplary or proposed terms for a deal. Recommender is an essential element in a mobile application where environmental parameters such as location come into play.

A deal recommender engine may match the denied requests to another business with the consent of the user/customer, thereby enabling the deal to be proposed to another merchant. The recommender may target users in order to promote deals, and make personalized offerings. In other words, the deal recommender may identify a possible candidate for a proposed deal based upon various personal characteristics including not only the purchase habits, income level, like purchases, etc.

In another embodiment, the deal recommender may permit each product/service (i.e., offerings) to be described in abstract terms by the merchants, and including meta-data related to product/service offerings. In this scenario, the recommender engine locates a merchant matching the set of abstract terms and displays that merchant and the associated terms to the user. Similarly, in the event that a deal is denied, merchants (those denying or possibly others) can take the denied requests and send their offer to the user. Or, in other scenarios, businesses can cooperate and bundle their product/service into one deal, and offer a bundled deal to users.

Turning to FIG. 4, depicted therein are graphical representations of the confidence of a particular deal, wherein data such as discount percentage, number of customers, time (peak, non-peak), etc. are used to characterize a confidence zone for a proposed deal. The zone is defined based upon merchant's characteristics/preferences as maintained in the merchants database of the PlayDeal system. Using the notion of a confidence zone, where boundaries are drawn by merchants, the system positions user requests in the depicted graphical representations to assess the likelihood of approval by the merchant. As discussed above relative to the deal ranker, the placement of a deal within a zone of high confidence may result in deal pre-approval, or at least an increased likelihood of acceptance.

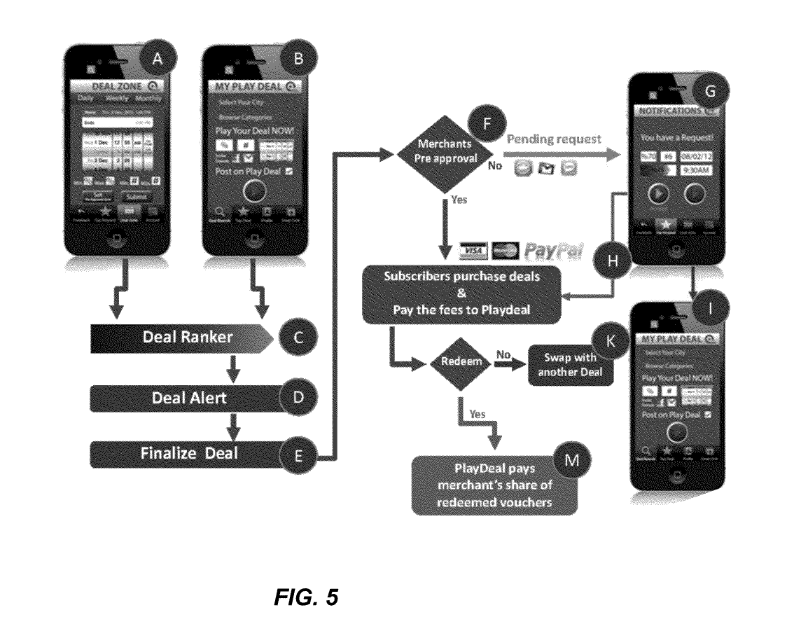

Referring to FIG. 5, depicted therein is a workflow for an exemplary transaction in accordance with one of the embodiments disclosed herein. The following serve to describe in more detail each of the workflow elements as depicted in the figure (see alphabetical references):
A—Deal zone is defined by merchant for specific time and corresponding max and min discounts and number of participants for peak and off-peak hours. Merchants can optionally define a approval zone which authorizes PlayDeal to accept the request on the behalf of merchants
B—Consumer can design and send their request to merchants. A request has discount, number of participants, and time of visit. They can invite their friends through social networks and email. Then they post their deals on PlayDeal, and wait for the response from PlayDeal
C—Deal ranker maps user's request to this zone. If the request lies in approval zone, request is accepted without requiring merchant's permission,
D—Otherwise deal ranker notifies the user about likelihood of acceptance.
E—Users can adjust the requests according to deal ranker guidelines, and send it back.
F—If request is not in approval zone, and user insists to send it to merchant, the request is sent to merchant as a pending request.
G—Merchants receive request notification and evaluated likelihood of acceptance. Then decide about the request and send the response back to user through PlayDeal, users wait until merchant accepts or rejects the request.
H—In case of approval, request turns into deal and user should pay for that.
I—stored in the system for the future. User can change discount, number of participants or time to make the request more acceptable.
K—If user fails to redeem the deal, then he can swap the purchased deal with another one
M—Eventually, Playdeal pays businesses share of money right away after redemption.

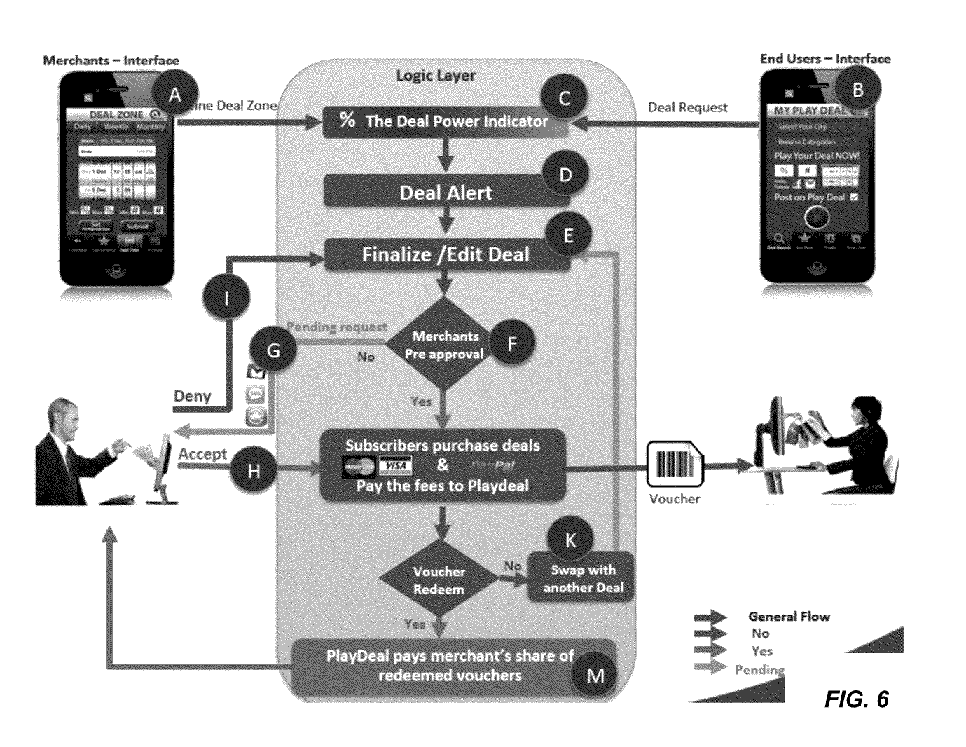

Referring to FIG. 6, depicted in the illustration is a work flow showing an alternative embodiment of the system and method. More specifically, two interfaces are provided. One interface is for consumers (MyPlayDeal) and one for merchants (DealZone). The DealZone (A) allows merchants to define specific times and corresponding max and min discounts and number of participants for peak and off-peak hours. Merchants can optionally define an approval zone which authorizes PlayDeal to accept the request on the behalf of merchants. Using the consumer interface (B) a Consumer can design and send their request to merchants. A request has discount, number of participants, and time of visit. They can invite their friends through social networks and email. Then they post their deals on PlayDeal, and wait for the response from PlayDeal. A represented by (C) the Deal ranker maps user's request to this zone. If the request lies in an approval zone, the request is accepted without requiring the merchant's permission. Otherwise, as represented by (D), the DealRanker notifies the user about a likelihood of acceptance.

As indicated at (E) users can adjust the requests according to deal ranker guidelines, and send it back for reconsideration. The deal is then reviewed once again at (F) to determine whether it falls within the merchant approval zone, and the user may also insist that the proposed deal be sent to the merchant. If so, the request is sent to merchant as a pending request (G). Merchant's receive request notification and evaluated likelihood of acceptance Then the merchant decides about the request and sends the response back to user through PlayDeal. Users wait until merchant accepts or rejects the request.

In case of approval, the request turns into deal, acceptance indicated at (H), and the user should pay for that. In case of denial by merchant (I), request is sent back to user for adjustment and history is stored in the system for the future. User can change discount, number of participants or time to make the request more acceptable.

As represented at (K), if a user fails to redeem a deal then the user can also swap the purchased deal with another approved deal. And, as characterized by (M), PlayDeal pays the merchant its share of the received funds upon redemption of the deal by the user.

Having described various aspects of the workflow, the following non-limiting example is intended to illustrate the power of customer offers and to further describe the deal ranking (DealRanker^{SM}) functionality associated with one aspect of the disclosed embodiments. One objective is to determine the power of customer offers (i.e., the likelihood of deal acceptance by the merchant) and ultimately guide them to ‘make a deal’. Power is calculated by taking into consideration three elements: 1) The min/max discount determined by the merchant; 2) The min/max number of customers the business can handle at any given time; and 3) The cycle of peak and off-peak hours, as determined by the business. As an example, high power implies that there is a high probability that the deal offered by the customer will be accepted by the merchant.

In this scenario there are groups of inputs: Merchant inputs including min/max discount determined, min/max number of customers that can be handled, and defining of the cycle of peak and off-peak hours; and customer inputs.

The following is an example of merchant or business input:
minDiscount=10%
maxDiscount=20%
minNumber=30
maxNumber=80
Times(sub zones):
   Off peak: 10:00-12:00, 16:00-18:00
   Rush hours : 12:00-14:00
   Normal hours: 14:00-16:00
   Day: All

The customer inputs include: preferred discount value, number of customer, and the specific time of deal desired. These inputs are elements of the proposed offer; power increases by increment of customer and decrement of discount.

The following is an example of customer inputs (i.e., preferred deal —highlighted row below):
Discount=25%
Number=70
Time=13:00
Day=Dec. 26, 2013

The output of this problem is a power percentage (e.g., 47% power) and a new suggestion to the customer in order to maximize power and thus, the likelihood of deal acceptance by the merchant. For example the following table reflects Customer states:

| Number of | | | |
|---|---|---|---|
| customers | Discount | Day/Time | Power |
| 70 | 25% | Dec. 26, 12:00-14:00 | 47% |
| 70 | 25% | Dec 26, 10:00-12:00 | 67% |
| 70 | 18% | Dec 26, 10:00-12:00, | 80% |
| | | 16:00-18:00 | |

In a model, Power of an offer is denoted by p_{d, n, t}(d, n, t), where n is the number of customers, d Is the value of discount, and t shows the time zone (i.e., cycle of peak and off-peak hours). The combination of n, d, t demonstrate that power is dependent upon the number of customers, the value of discount, and the time zone (Eq. 1). In this equation p_{d}(d), pₙ(n), and pₜ(t) represent the effect of discount, number of customers, and time in power.

p_{d,n,t}(d, n)=p_{d}(d)*pₙ(n)*pₜ(t) Eq. 1

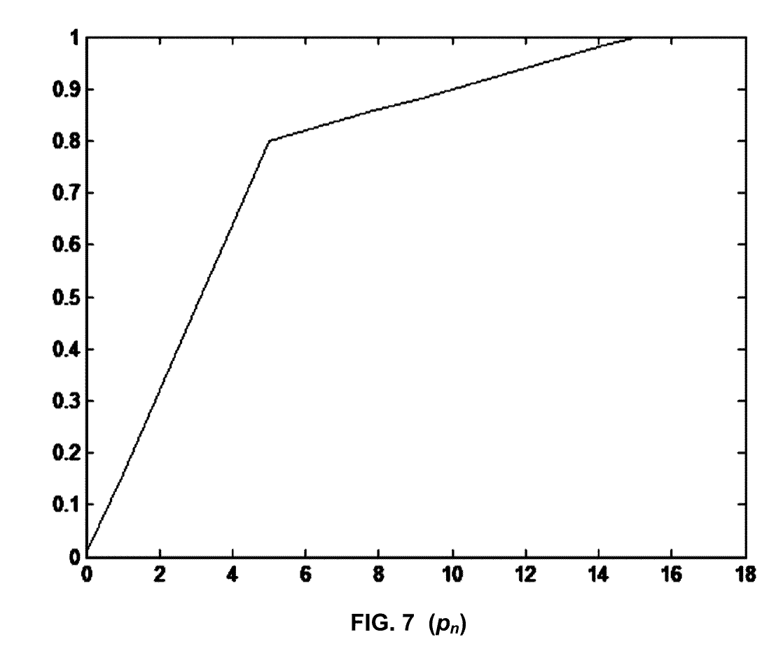

To calculate pₙ(n), n is divided into three parts:
1. n≦minNumber: The number of customers is below the minimum number specified by merchant.
2. minNumber<n≦maxNumber: The number of customer is within the range determined by the merchant.
3. n>maxNumber: The number of customers is greater than the range determined by the merchant.
   In Part 1 and part 2 above, pₙ(n) is calculated by two lines with different slopes. In part 3 above, pₙ(n)=1 if business accepts offer with customer number greater than the maximum number of customers, otherwise it is zero (Eq. 2). a₁, a₂, b₁ and b₂ are model parameters. FIG. 7 shows an example when minNumber=6 and maxNumber=15.

$${p}_{n} ( n ) = \{ \begin{matrix}{a}_{1} \times n + {b}_{1} & n \leq minNumber \\ {a}_{2} \times n + {b}_{2} & n \leq maxNumber \\ 1 & n \leq minNumber\end{matrix} \qquad Eq . 2$$

To calculate p_{d}(d), d is divided into three parts:
1. d<minDiscount
2. minDiscount<d<maxDiscount
3. d>maxDiscount
   In the first part p_{d}(d)=1. In part 2, p_{d}(d) models as a line, and in part 3, p_{d}(d) models by exponential function (Eq. 3). a₃, b₃, a₄ and b₄ are model parameters.

$${p}_{d} ( d ) = \{ \begin{matrix}1 & d \leq minDiscount \\ {a}_{3} \times d + {b}_{3} & minDiscount < d < maxDiscount \\ {b}_{4} \times exp ( - {a}_{4} \times {( d - maxDiscount )}^{2} ) & d \geq maxDiscount\end{matrix} \qquad Eq . 3$$

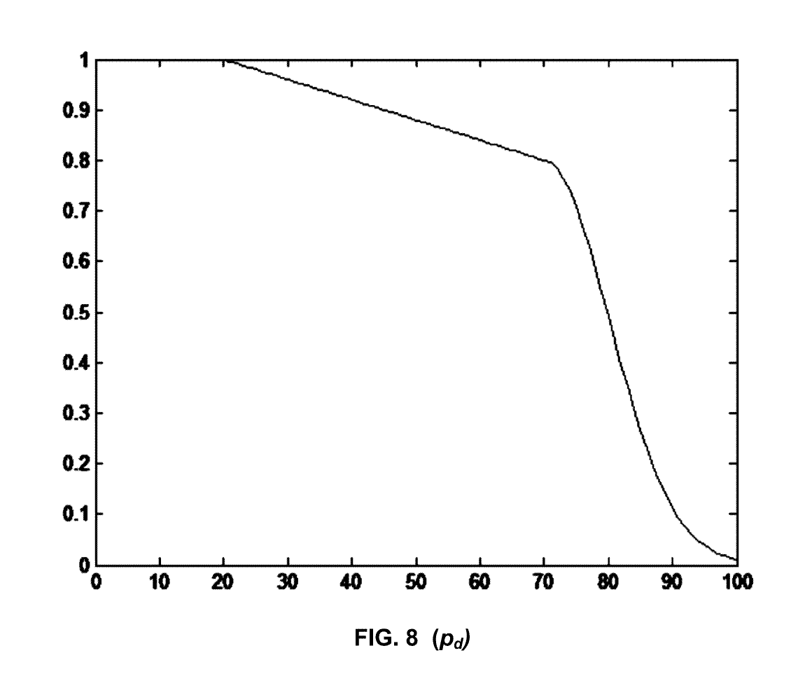

FIG. 8 shows an example when minDiscount=20% and maxDiscount=75%. And, since there is three time zones (off peak, Normal hours and Rush hours) we model pₜ(t) by three parameters.

$${p}_{t} ( t ) = \{ \begin{matrix}1 & t is in off peak times \\ {th}_{normal} & t is in Normal hours \\ {th}_{rush} & t is in Rush hours\end{matrix} \qquad Eq . 4$$

Initial conditions are used to model parameters in Eq. 2 and Eq. 3. The values of pₙ(n) and p_{d}(d) are equal to 1 when n=maxNumber and d=minDiscount. In other words, min discount and max number in an offer do not decry the power of it (Eq. 5 and Eq. 6).

pₙ(maxNumber)=1 Eq. 5

p_{d}(minDiscount)=1 Eq. 6

Also, it is assumed that business provides max (min) discount when the number of customers is maxNumber (minNumber). So, value of power in these points is acceptance threshold (Eq. 7-9).

p_{d,n,t}(maxDiscount, maxNumber, 0)=thp Eq. 7

p_{d,n,t}(minDiscount, minNumber, 0)=thp Eq. 8

thp=0.8 Eq. 9

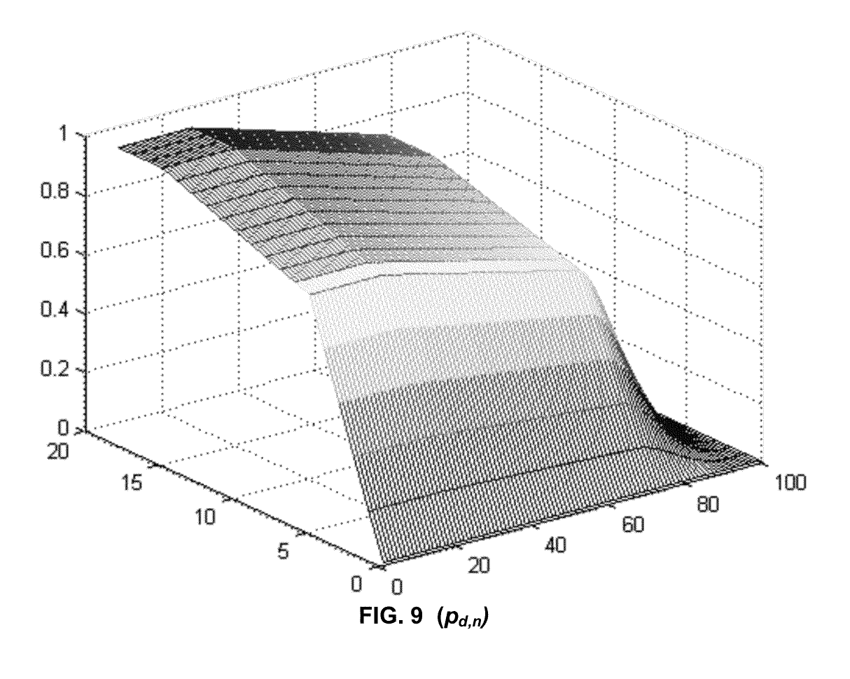

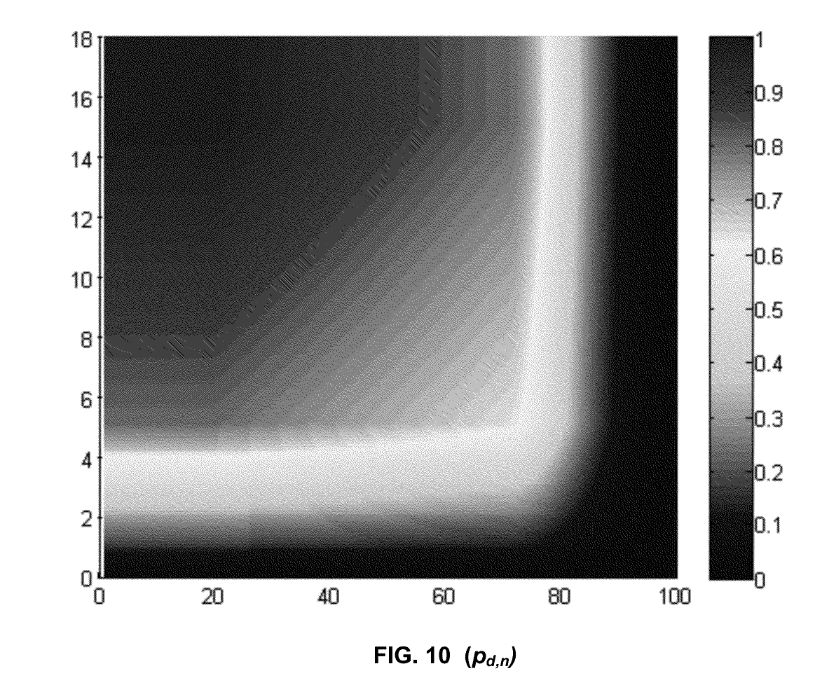

The above assumptions are enough to calculate the model parameters. For example, for the following inputs, the power for different discount and number of customer can be calculated, and FIGS. 9 and 10 illustrate the power.

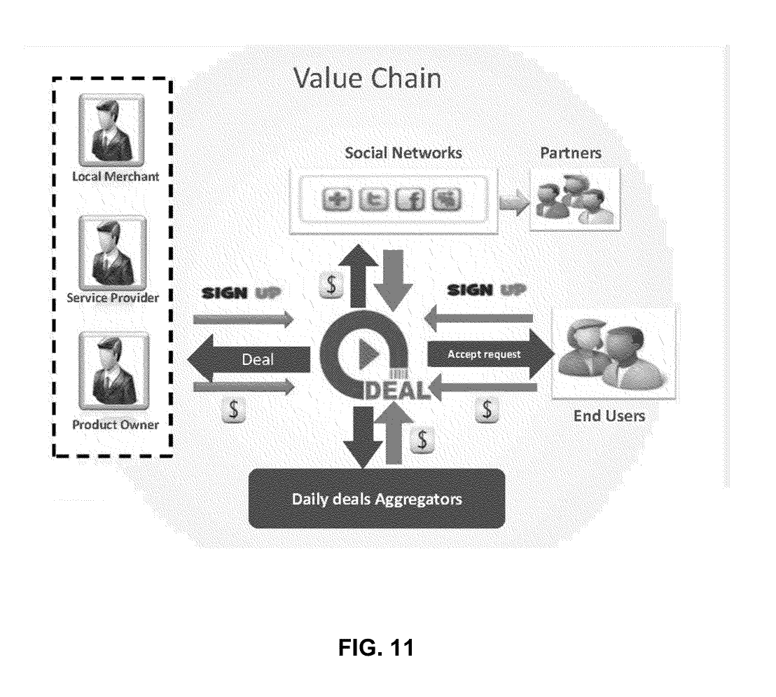

Turning briefly to FIG. 11, depicted therein is an exemplary characterization illustrating the relationships of the various users. As illustrated the PlayDeal system itself (center), enables interaction and group dealmaking with those that have something to sell on the left, and those that are interested in purchasing on the right.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A buyer client data processing system for sourcing an item for purchase, comprising:
a computer-based processor and associated memory in which programmatic instructions may be stored, said processor being suitable for executing programmatic instructions;
a database accessible by said processor, said database including a repository storing information for a plurality of businesses along with products of the business and their specifications;
a user database storing user profiles for users of the system;
a deal request interface for an end user, said interface including fields in which the user specifies the proposed deal; and
a deal ranker, operating on the proposed deal from the user, the deal ranker producing an output representing a likelihood that the proposed deal will be accepted by a merchant based on merchant specified information stored in the database.

2. The system according to claim 1 wherein said deal request interface receives at least three inputs from user, the inputs including: time of redemption, number of coupons, and discount.

3. The system according to claim 1 wherein said deal ranker receives inputs from merchants, stored in the database, and processes the inputs to establish a confidence zone.

4. The system according to claim 3 wherein the confidence zone characterizes a boundary where a deal is likely to be approved by a merchant.

5. The system according to claim 4, wherein the confidence zone includes merchant defined hours.

6. The system according to claim 4, wherein the confidence zone further permits merchants to define the amount of a discount based upon the hours in which the discount is available.

7. The system according to claim 4, wherein a merchant may define a minimum that must be purchased in order to accept a deal.

8. The system according to claim 4, wherein proposed deals are accepted without merchant permission when the proposed deals fall within the confidence zone.

9. The system according to claim 1, wherein the repository includes all business products offered by a merchant.

10. The system according to claim 4 wherein the system receives requests in real-time, and in case a proposed deal is outside the confidence zone the system redirects the request immediately to the merchant, and subsequently, a decision is sent back to the user.

11. The system according to claim 1, wherein users can send proposed deal requests through a mobile application.

12. The system according to claim 1, further comprising:
a recommender engine that matches denied proposed deal requests to another merchant with the consent of users.

13. The recommender engine according to claim 12, wherein merchants are able to target users in order to promote deals, and make personalized offerings.

14. The system according to claim 12, wherein said recommender engine processes descriptions of each merchant offering using metadata related to the offerings, and where the recommender engine locates another merchant matching the set of terms to the metadata and displays the matching results to the user.

15. The system according to claim 1, wherein merchants can take the denied requests and send offers to the user.

16. The system according to claim 1, wherein merchants cooperate and bundle their offerings into a deal, and offer the deal to users.

17. A method, operating on a computer-based processor and associated memory in which programmatic instructions may be stored, for sourcing a featured item for purchase, comprising:
creating a database accessible by said processor, said database including a repository storing information for a plurality of businesses along with offerings of the business, as well as specifications for said offerings;
storing user profiles for users of the system;
providing a deal request interface for a consumer, said interface including fields in which the user specifies the proposed deal; and
ranking the proposed deal from the user, and producing an output representing a likelihood that the proposed deal will be accepted by a merchant based on merchant specified information stored in the database.

18. The method according to claim 17 wherein the ranking includes determining the power of the proposed deal.
